(19) United States
(12) Patent Application Publication
(10) Pub. No.: US 2015/0095568 A1
(43) Pub. Date: Apr. 2, 2015

(54) STORAGE SYSTEM AND STORAGE DEVICE CONFIGURATION REPORTING

(71) Applicant: INTERNATIONAL BUSINESS MACHINES CORPORATION, Armonk, NY (US)

(72) Inventors: Michael L. Lamb, Leander, TX (US); Shahbaz A. Shaik, Bangalore (IN)

(73) Assignee: INTERNATIONAL BUSINESS MACHINES CORPORATION, Armonk, NY (US)

(21) Appl. No.: 14/042,552

(22) Filed: Sep. 30, 2013

(51) Int. Cl. G06F 3/06

(52) U.S. Cl. CPC G06F 3/0629; G06F 3/0689; G06F 3/0619
USPC 711/114; 711/170

(57) ABSTRACT

A storage environment includes a storage system and a reporting device. The storage system may operate in a first configuration utilizing only internal storage and may operate in a second configuration utilizing only external storage. The reporting device determines the operating configuration of the storage system and generates a report comprising at least one field identifying the storage system and at least one field identifying the operating configuration of the storage system. The storage system may also include a managed disk group that may operate in a first configuration comprising only internal storage and may operate in a second configuration comprising only external storage. The reporting device may determine the operating configuration of the managed disk group and generates a report including at least one field identifying the managed disk group and at least one field identifying the operating configuration of the managed disk group.

### FIELD

Embodiments of invention generally relate to storage systems and storage devices, and more particularly to reporting on multiple configurations of storage systems and/or storage devices.

### DESCRIPTION OF THE RELATED ART

Some storage systems have the ability to utilize virtualize storage external to the system while also having the ability to utilize internal storage within the system. Therefore, these types of storage systems may operate in various configurations. However, storage system reporting has traditionally assumed that storage systems have a single configuration.

### SUMMARY

Embodiments of invention generally relate to storage systems and storage devices, and more particularly to reporting on multiple configurations of storage systems and/or storage devices.

In a first embodiment of the present invention, a storage environment includes a storage system that may operate in a first configuration utilizing only internal storage and that may operate in a second configuration utilizing only external storage, and a reporting device that determines the operating configuration of the storage system and generates a report comprising at least one field identifying the storage system and at least one field identifying the operating configuration of the storage system.

In another embodiment of the present invention, a storage environment includes a storage system comprising a plurality of managed disk groups, each particular managed disk group operating in a first configuration comprising only internal storage and may operate in a second configuration comprising only external storage, and a reporting device that determines the operating configuration of at least one managed disk group and generates a report comprising at least one field identifying the managed disk group and at least one field identifying the operating configuration of the managed disk group.

In yet another embodiment of the present invention, a report includes at least one field identifying a storage system that may operate in a first configuration utilizing only internal storage and that may operate in a second configuration utilizing only external storage, and at least one field identifying the operating configuration of the storage system.

These and other embodiments, features, aspects, and advantages will become better understood with reference to the following description, appended claims, and accompanying drawings.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a storage environment, according to various embodiments of the present invention.

FIG. 2A depicts a storage system that may operate in various configurations, according to various embodiments of the present invention.

FIG. 2B depicts a storage device that may operate in various configurations, according to various embodiments of the present invention.

FIG. 3 depicts a storage system operating in an internal storage configuration, according to various embodiments of the present invention.

FIG. 4 depicts a storage system operating in an external storage configuration, according to various embodiments of the present invention.

FIG. 5 depicts a storage system operating in an internal and external storage configuration, according to various embodiments of the present invention.

FIG. 6 depicts a storage environment, according to various embodiments of the present invention.

FIG. 7 depicts an exemplary storage system report, according to various embodiments of the present invention.

FIG. 8 depicts an exemplary storage device report, according to various embodiments of the present invention.

FIG. 9 depicts a block diagram of a method of managing storage system and/or storage device configuration information, according to various embodiments of the present invention.

FIG. 10 depicts a block diagram of a method of updating storage system and/or storage device configuration information, according to various embodiments of the present invention.

FIG. 11 depicts a block diagram of a method of reporting storage system and/or storage device configuration information, according to various embodiments of the present invention.

FIG. 12 depicts a block diagram of a method of determining storage system and/or storage device configuration, according to various embodiments of the present invention.

### DETAILED DESCRIPTION

Details of the claimed embodiments are disclosed herein. However, it is understood that the disclosed embodiments are merely illustrative of the structures, devices, systems, methods, etc. that may be embodied in various forms. These exemplary embodiments are provided so that this disclosure will be thorough and complete and will convey the scope of this invention to those skilled in the art. In the description, details of well-known features and techniques may be omitted to avoid unnecessarily obscuring the presented embodiments.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “device,” “manager” or “system.” Furthermore, aspects of the present invention may take the form of a computer program product embodied in one or more computer readable medium(s) having computer readable program code embodied thereon. Any combination of one or more computer readable medium(s) may be utilized.

The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The drawings are not necessarily to scale. The drawings are merely schematic representations, not intended to portray specific parameters of the invention. The drawings are intended to depict only exemplary embodiments of the invention. In the drawings, like numbering represents like elements.

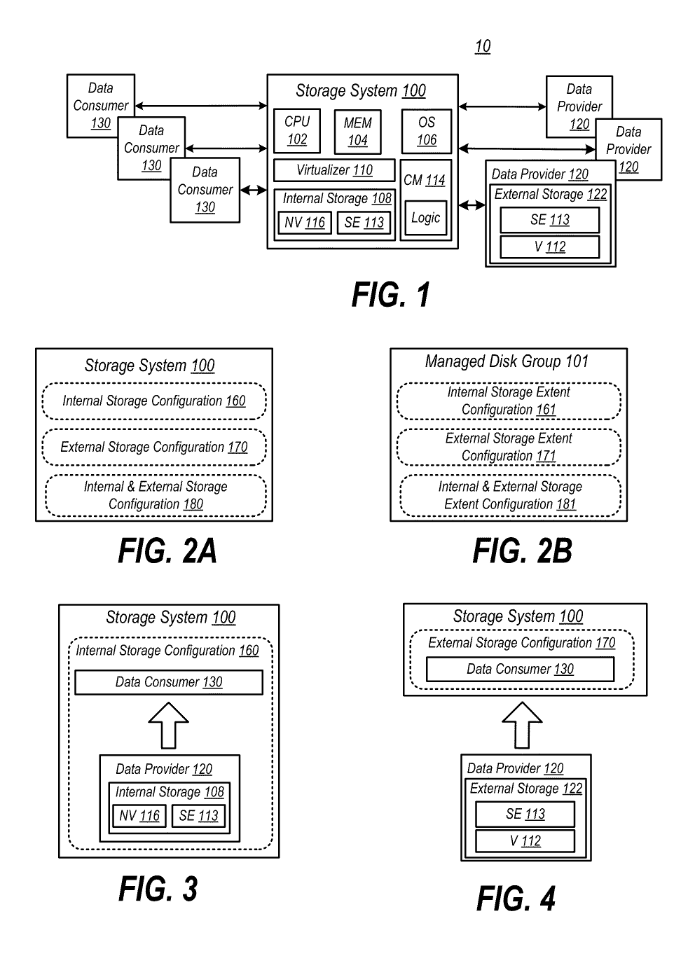

FIG. 1 depicts a storage environment 10 that includes at least a storage system 100, according to various embodiments of the present invention. In other embodiments, storage environment 10 also includes one or more data providers 120 that provide data to storage system 100 and/or one or more data consumers 130 that consume data from storage system 100.

In certain implementations, storage environment 10 may be embodied within a single enclosure. For example, storage environment 10 may be a storage server having one or more storage modules. Each storage module may be an independent from other modules and may each include, for example, a central processing unit (CPU) 102, memory 104, operating software 106, internal interconnections, internal storage 108, and other subcomponents. In embodiments with multiple storage modules, each storage module may be interconnected using, for example, InfiniBand, Ethernet, high speed bus, etc. In certain embodiments, storage system 100 is a single storage module 100 and other various storage modules may be data providers 120 and/or data consumers 130. Additionally, storage environment 10 may be implemented with multiple enclosures. For example, storage system 100 be a stand alone system external from various other stand alone data providers 120 and/or data consumers 130 systems. In this example, storage system 100 may be connected to data providers 120 and/or data consumers 130 by wired and/or optical connections, a network, etc.

In certain embodiments, storage system 100 is a storage system that may operate in various configurations. For example, storage system 100 may operate in an internal storage configuration 160, an external storage configuration 170, or an internal and external storage configuration 180. Storage system 100 may include a CPU 102, memory 104, operating software 106, internal storage 108, virtualizer 110, and configuration manager 114. In various embodiments, storage system 100 may provide either block accessed storage (e.g. Fibre Channel, iSCSI, SAS, FICON, etc.) or file accessed storage (NFS, CIFS, etc.).

Storage system 100 may include a CPU 102 connected to a memory 104 by a system bus (not shown). The CPU 102 may execute program instructions stored in memory 104. Although a single CPU 102 is shown, it should be understood that storage system 100 may have multiple CPUs 102.

Memory 104 may be physically included within CPU 102 or connected to it via the system bus. Memory 104 may be for example a random access semiconductor memory for storing data and/or program instructions, code, logic, etc. Though memory 104 is shown conceptually as a single monolithic entity, memory 104 may be arranged as a hierarchy of caches and other memory devices. In some instances, a hierarchy of cache memories are associated with each CPU 102. Memory 104 includes operating software 106. Operating software 106 may include an operating system that provides functions such as device drivers or interfaces, management of memory pages, management of multiple tasks, etc., as is known in the art. Operating software 106 may also include applications that may for example include a storage software application whereby a storage system 100 network interface may interact with the storage software application to enable storage system 100 to be a storage server.

The system bus may support the transfer of data, commands, and other information between CPU 102 and peripheral or external devices (e.g. data provider 120, data consumer 130, etc.) attached to it, and communication of data which may occur between the external devices independent of CPU 102. The system bus may be structured as multiple buses which may be, for example, hierarchically arranged. System bus may be connected to other storage system 100 components (such as configuration manager 114, internal storage 108, etc.) and/or to a myriad of external or peripheral devices through a connection hub, through an adapter, or directly to a network.

The system bus may be connected to an adapter (not shown) included in storage system 100. The adapter may include adapter microcode or firmware and decision logic may also be provided with at least one fast nonvolatile write cache, queues, interrupt registers, etc. The adapter may process incoming messages from data provider 120 or process outgoing messages to data consumer 130. The adapter may contain electronic components and logic to adapt or convert data of one protocol on one bus to another protocol on another bus. In certain embodiments various adapters are included within storage environment 10 (e.g. within storage system 100, within data provider 120, within data consumer 130, etc.). Therefore, the adapter may connect storage system 100 to various data providers 120 and/or data consumers using one or more protocols including, but not limited to, Token Ring, Gigabyte Ethernet, Ethernet, Fibre Channel, SSA, storage area network (SAN), Fiber Channel Arbitrated Loop (FCAL), Serial SCSI, Ultra3 SCSI, Infiniband, FDDI, ATM, 1394, ESCON, wireless relays, Twinax, LAN connections, WAN connections, etc.

The system bus may be directly connected to a network interface (not shown) that provides an operative connection for transmission of data to data consumer 130 or for receipt of data from data provider 120. The network may be an internet but could also be any smaller self-contained network such as an intranet, a WAN, a LAN, or other internal or external network using; e.g., telephone transmission lines, cable services, satellites, fiber optics, T1 lines, wireless, etc.

In certain embodiments, storage system 100 includes internal storage 108. Internal storage 108 may be rotating magnetic disk storage, rotating or static optical drives, magnetic tape storage, FLASH memory, etc. internal to storage system 100. In certain embodiments, internal storage 108 is connected to CPU 102, memory 104, etc. via the system bus. In various embodiments, internal storage 108 may contain a plurality of storage extents 113. For the purposes of this document a storage extent 133 may be any contiguous area of storage (e.g. an contiguous area for a file, block, etc.) used to store data. In certain embodiments, internal storage also includes a non virtual storage space 116. Non virtual storage space 116 is an area of internal storage 108 that is not virtualized. In certain embodiments various storage extents 113 are contained within non virtual storage space 116.

In certain embodiments, storage system 100 may include a configuration manager 114. Configuration manager may be a hardware component such as a field programmable gate array (FPGA) or application specific integrated circuit (ASIC) connected to CPU 102 and memory 104 via the system bus, or it may be a software component or logic module, such as an operating software application. In accordance with various embodiments further disclosed herein, configuration manager 114 manages storage system 100 configuration information, manages the updating of storage system configuration information, and/or transmits storage system 100 configuration information, etc.

In certain embodiments, storage system 100 may include a virtualizer 110. Generally, virtualizer 110 is software or hardware or a combination that provides storage virtualization. Virtualizer 110 abstracts or separates a logical storage (e.g. a storage partition, etc.) from physical storage so that it may be accessed without regard to physical storage location or heterogeneous structure. For example, virtualizer 110 presents a logical data storage space and handles the process of mapping the logical data storage space to the actual physical storage location. In certain embodiments, virtualizer 110 allows storage system 100 to store data externally (e.g. within external storage 122, etc.). For example, virtualizer 110 provides logical data storage space to CPU 102, memory 104, etc. and maps the logical data storage space to the physical location (e.g. block address, file, etc.) within external storage 122. In certain embodiments, virtualizer 110 aggregates the physical storage resources available within storage environment 10 (e.g. internal storage 108, external storage 122, etc.) into managed disk groups, from which the logical storage is created. In certain embodiments, virtualizer 110 servers as a storage manager of all the resources within storage environment 10. Depending upon the implemented storage environment 10, virtualizer 110 may provide host-based virtualization, storage device based virtualization, or network based virtualization.

A particular managed disk group may include only storage extents 113 within internal storage 118. Another managed disk group may include storage extents 113 only within external storage 122. Still in certain other embodiments, another managed disk group may include storage extents within both internal storage 118 and external storage 122.

In certain embodiments, storage environment 10 also includes one or more data providers 120 and/or one or more data consumers 130. Data consumer 130 is any device that obtains or consumes data. An exemplary data consumer 130 is a second storage system 100b within storage environment 10, a host server connected to storage system 100a, computer connected to storage system 100a, etc.

Data provider 120 is any device that stores and/or provides data. An exemplary data provider 120 is a third storage system 100c within storage environment 10, enclosure of external storage disks connected to storage system 100a, etc. In certain embodiments, storage system 100 stores data in external storage 122 of a data provider 120. External storage 122 may be rotating magnetic disk storage, rotating or static optical drives, magnetic tape storage, FLASH memory, etc. located outside of storage system 100. In various embodiments, external storage 122 may contain a plurality of storage extents 113. In certain embodiments, external storage 122 also includes a virtual storage space 112. Virtual storage space 112 is an area of external storage 122 that is virtualized. In other words, virtual storage space 112 is the area within external storage that virtualizer 110 maps to the logical data storage space to allow storage system 100 to store data externally. In certain embodiments, various storage extents 113 are contained within virtual storage space 112.

The storage environment 10 shown in FIG. 1 is intended to be a simplified representation, it being understood that many variations in storage environment 10 and/or storage system 100 implementation are possible in addition to those specifically mentioned herein.

FIG. 2A depicts storage system 100 that may operate in various configurations, according to various embodiments of the present invention. Storage system 100 may operate in an internal storage configuration 160, an external storage configuration 170, or an internal and external storage configuration 180. When storage system 100 utilizes only internal storage 108, storage system 100 is operating in internal storage configuration 160. When storage system 100 utilizes only external storage 122, storage system 100 is operating in external storage configuration 170. When storage system 100 utilizes both internal storage 108 and external storage 122, storage system 100 is operating in internal and external storage configuration 180.

FIG. 2B depicts a storage device that may operate in various configurations, according to various embodiments of the present invention. For the purposes of this document, storage device may be synonymous with managed disk group. In certain embodiments storage system 100 may include a plurality of managed disk groups 101. Each managed disk group 101 may operate in an internal storage extent configuration 161, an external storage extent configuration 171, or an internal and external storage extent configuration 181. A managed disk group 101 may operate in an internal storage extent configuration 161 if the managed disk group 101 includes only storage extents 113 within internal storage 118. A managed disk group 101 may operate in an external storage extent configuration 171 if the managed disk group 101 includes storage extents 113 only within external storage 122. A managed disk group 101 may operate in an internal and external storage extent configuration 181 if the managed disk group 101 includes both storage extents 113 within both internal storage 118 and external storage 122.

For the purposes of the remaining portions of this document, internal configuration is generically used to refer to as internal storage configuration 160 or internal storage extent configuration 161, the context of which may be inferred by the subject (i.e. storage system 100 or managed disk group 101) Likewise, external configuration is generically used to refer to as external storage configuration 170 and external storage extent configuration 171 Likewise, internal and external configuration is generically used to refer to as internal and external storage configuration 180 and internal and external storage extent configuration 181.

FIG. 3 depicts storage system 100 operating in internal storage configuration 160, according to various embodiments of the present invention. When storage system 100 operates in internal storage configuration 160, storage system 100 is both a data consumer 130 and data provider 120 since it obtains or consumes data provided by it's own internal storage 108.

FIG. 4 depicts storage system 100 operating in external storage configuration 170, according to various embodiments of the present invention. When storage system 100 operates in external storage configuration 170, storage system 100 is only a data consumer 130 since it only obtains or consumes data from external storage 122 of a data provider 120.

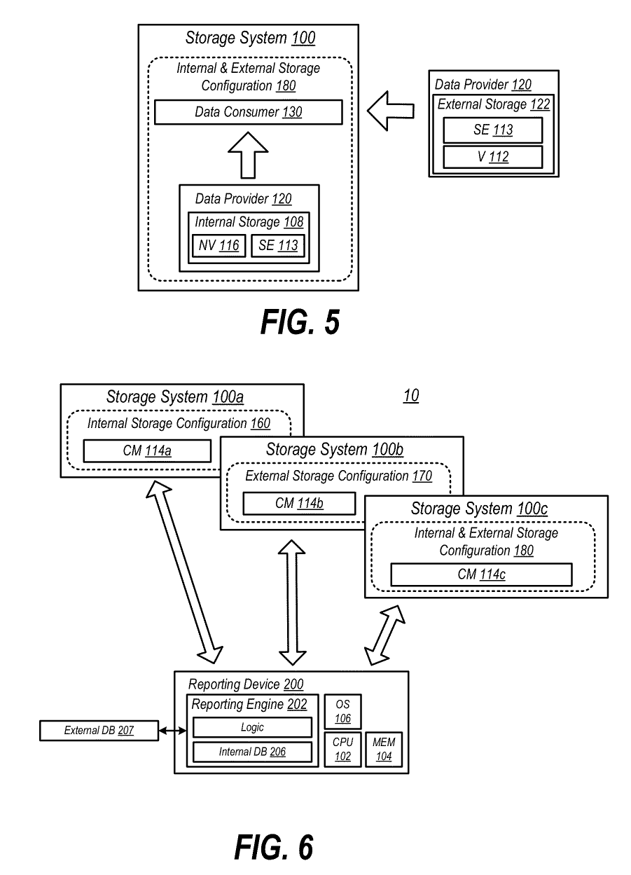

FIG. 5 depicts storage system 100 operating in internal and external storage configuration 180, according to various embodiments of the present invention. When storage system 100 operates in internal and external storage configuration 180, storage system 100 is both a data consumer 130 and data provider 120 since it obtains or consumes data provided by it's own internal storage 108 and provided by external storage 122 of a data provider 120.

FIG. 6 depicts storage environment 10 that includes a reporting device 200, according to various embodiments of the present invention. Reporting device 200 is both a data provider 120 and a data consumer 130 and in certain embodiments, reporting device 200 may be a stand alone device (e.g. blade server, computer, etc.) within storage environment 10. In other embodiments, reporting device 200 may be an FPGA or ASIC within storage system 100 that is connected to CPU 102 and memory 104 via the system bus. Still in other embodiments, it may be a software component or logic module, such as an operating software application, within storage system 100. Still in other embodiments, it may be a software component or logic module within an storage environment 10 optimization or management application located on a storage environment 10 controller. Depending upon the implementation, reporting device may include and/or utilize CPU 102, memory 104, operating software 106, system bus (not shown), etc.

In certain embodiments, reporting device 200 generates reports that include configuration information. Ultimately, these reports may be displayed to a user to depict useful information about the subject of the report (e.g. storage system 100). For example, reporting device 200 may generate reports for particular storage systems 100a, 100b, and/or 100c, respectively. Reporting device 200 may also generate reports for particular managed disk groups. A report may identify one or more storage systems 100 and associated storage system 100 configurations. Also a report may include one or more managed group disks and associated configuration information. Reporting device 200 may be communicatively connected to configuration manager 114 in order to effectively receive information used to determine the configuration and to ultimately generate reports.

In certain embodiments, reporting device 200 includes a reporting engine 202 that includes one or more logic modules and a database. Depending upon the implementation of reporting device 200, the database may be an internal database 206 or it may be an external database 207. The database includes information about the status, state, operating conditions, etc. of storage system 100, managed disk group 101, etc. Further, the database includes information about the configuration of storage system 100, managed disk group 101, etc

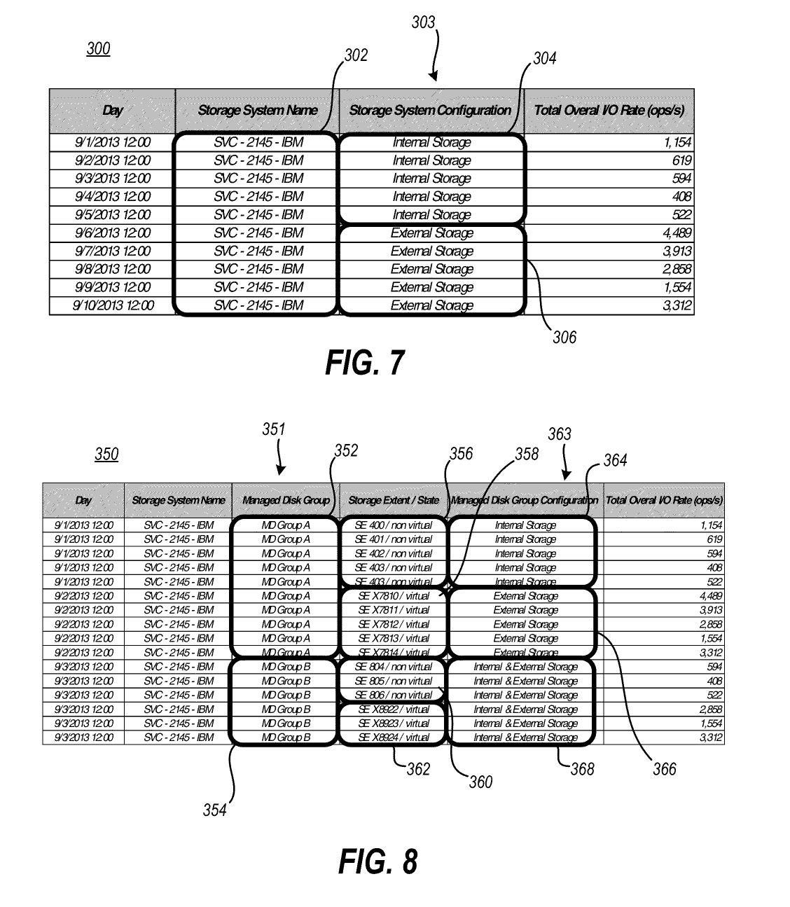

FIG. 7 depicts an exemplary storage system report 300, according to various embodiments of the present invention. Storage system report 300 is generally a report that includes at least the configuration associated with at least one storage system 100. In certain embodiments, storage system report 300 also includes other useful information associated with at least one storage system 100 (e.g. input/output rate, etc.). According to various embodiments, storage system report 300 includes storage system identification fields 302 and storage system configuration fields 303. Storage system report 300 identifies that a particular storage system 100 (i.e. SVC-2145-IBM) was operating in internal storage configuration 160 in fields 304 and identifies that the storage system 100 was operating in an external storage configuration 170 in fields 306 at various times.

FIG. 8 depicts an exemplary storage device report 350, according to various embodiments of the present invention. Storage device report 350 is generally a report that includes at least the configuration associated with at least one managed disk group. In certain embodiments, storage device report 350 also includes other useful information associated with at least one managed disk group (e.g. storage extent 113 identification, storage extent 113 state, etc.). According to various embodiments, storage device report 350 includes managed disk group identification fields 351 and managed disk group configuration fields 363. Storage device report 350 identifies that a particular managed disk group (i.e. MD Group A) identified in field 352 operated in internal storage extent configuration 161 in fields 364 and identifies that the managed disk group operated in external storage extent configuration 171 in fields 366 at various time instances. Storage device report 350 may also identify that a particular managed disk group (i.e. MD Group B) identified in field 354 operated in internal and external storage extent 181 in field 368. In certain embodiments, storage device report 350 may also identify one or more storage extents and/or the states of those storage extends in fields 356, 358, 360, and 362, respectively.

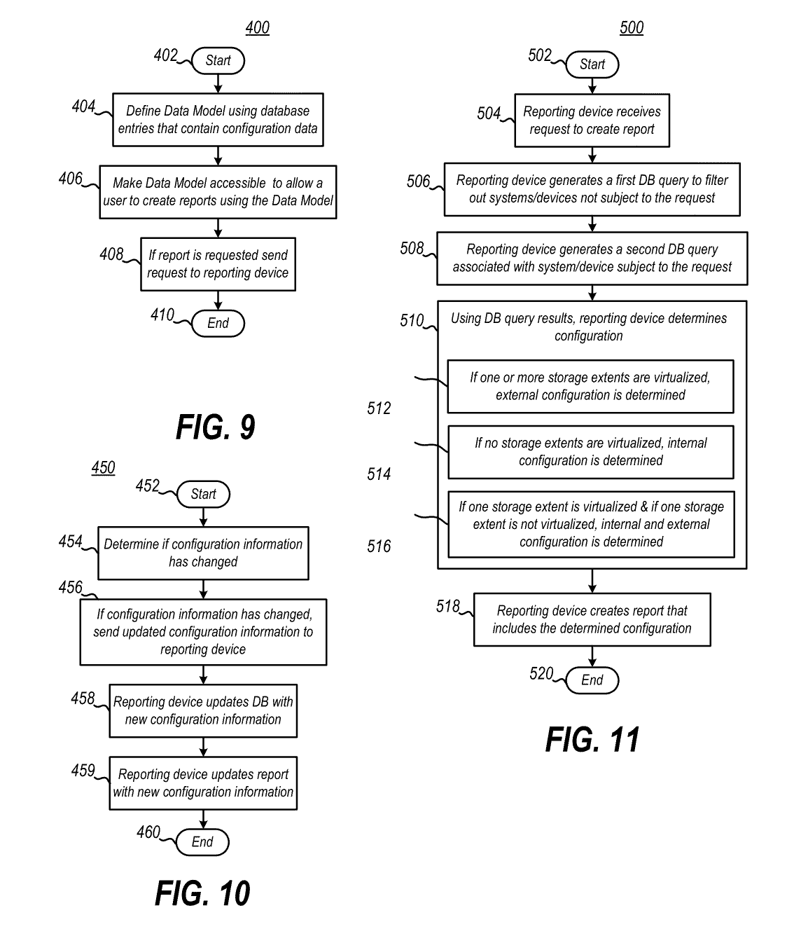

FIG. 9 depicts a block diagram of a method 400 of managing storage system 100 and/or storage device configuration information, according to various embodiments of the present invention. In certain embodiments, method 400 may be implemented by configuration manager 114 to manage, and allow access by a user to, configuration information. In certain embodiments, method 400 may be implemented by configuration manager 114 in conjunction with other components within storage environment 10 to manage and make accessible configuration information. Method 400 begins at block 402 and continues with defining a database model using database (i.e. internal database 206, external database 207) entries that contain configuration information (block 404).

A database model is a specification describing how internal database 206 or external database 207 is structured and used. For example, configuration manager 114, reporting engine 202, etc. may define a flat database model, an hierarchical database model, a network database model, a relational database model, flat or table database model, an hierarchical database model, network database model, a relational database model, a concept-oriented database model, object-relational database model, etc.

Method 400 continues by making the data base model accessible to a user to allow a user to create reports including storage system or storage device configuration using the database model (block 406). For example, a interface (e.g. graphical user interface, etc.) may be presented to the user to request the creation of the report. The same or a different interface may be blitzed to eventually display a generated report. When the report is requested by the user, a report creation request is sent to a reporting device (block 408). For example, configuration manager 114 sends the report creation request to reporting engine 202. Method 400 ends at block 410.

FIG. 10 depicts a block diagram of a method 450 of updating configuration information, according to various embodiments of the present invention. In certain embodiments, method 450 may be implemented by configuration manager 114 and/or reporting device to update configuration information within reporting device 200. In certain embodiments, method 450 may be implemented in conjunction with other components within storage environment 10 to update configuration information within reporting device 200.

Method 450 begins at block 452 and continues with determining if configuration information has changed (block 454). For example, configuration manager 114 determines if the configuration of storage system 100 has changed from a previous configuration and/or if the configuration of a managed disk group 101 has changed from a previous configuration. Method 450 continues by sending updated configuration information to reporting device 200 if the configuration has changed (block 456). For example, configuration manager 114 sends the new configuration of storage system 100 and/or sends the new configuration of managed disk group 101 to reporting engine 202. Method 450 continues with reporting device 200 updating the database with the new configuration information (block 458). For example, reporting engine 202 updates internal database 206 and/or external database 207 with the new configuration conformation. In certain embodiments, reporting device 200 may update the report and/or reads the internal database 206 and/or external database 207 to subsequently generate an updated or new report with the new configuration (block 459). Method 450 ends at block 460.

FIG. 11 depicts a block diagram of a method 500 of generating a report containing configuration information, according to various embodiments of the present invention. In certain embodiments, method 500 may be implemented by reporting device 200 to create a report that includes configuration information. In certain embodiments, method 500 may be implemented by reporting device 200 in conjunction with other components within storage environment 10 to create a report that includes configuration information.

Method 500 begins at block 502 and continues with reporting device 200 receiving a request to generate a report that shall include configuration information (block 504). For example, reporting engine 202 may receive the report generation request from configuration manager 114. Method 500 continues with the reporting device 200 generating a first database query to filter out all storage systems 100 and/or managed group disks 101 that are not associated with or subject to the request (block 504). For example, if the report request is associated only with storage system 100b, reporting engine 202 generates the first query to filter out or remove storage systems 100a, 100c, etc. Method 500 continues with reporting device 200 generating a second database query associated with the storage system 100 and/or the managed group disk 101 that are subject to the request (block 508). The second query may identify the various fields that should be included in the report. For example, the reporting engine 202 generates a second query to indicate that the report should include a particular storage system 100b and/or a particular managed disk group 101a and at least the configuration information associated therewith. In various embodiments, the second query may also specify the other information that should be included in the report (e.g. dates, times, storage extents, storage extent states, I/O rates, etc.).

Method 500 continues with the reporting device 200 determining the configuration (block 510). If one or more of the storage extents within the manage disk group 101 and/or the storage system 100 associated with the second query are virtualized, a external storage configuration is determined (block 512). If no storage extents within the manage disk group 101 and/or the storage system 100 associated with the second query are virtualized, a internal storage configuration is determined (block 514). If one or more of the storage extents within the manage disk group 101 and/or the storage system 100 associated with the second query are virtualized and if one or more of the storage extents within the manage disk group 101 and/or the storage system 100 associated with the second query are not virtualized an internal and external storage configuration is determined (block 516).

Method 500 continues with the reporting device 200 generating a report that has the determined configuration included therein (block 518). In certain embodiments the report is sent and displayed to the user via for example, an interface, etc. Method 500 ends at block 520.

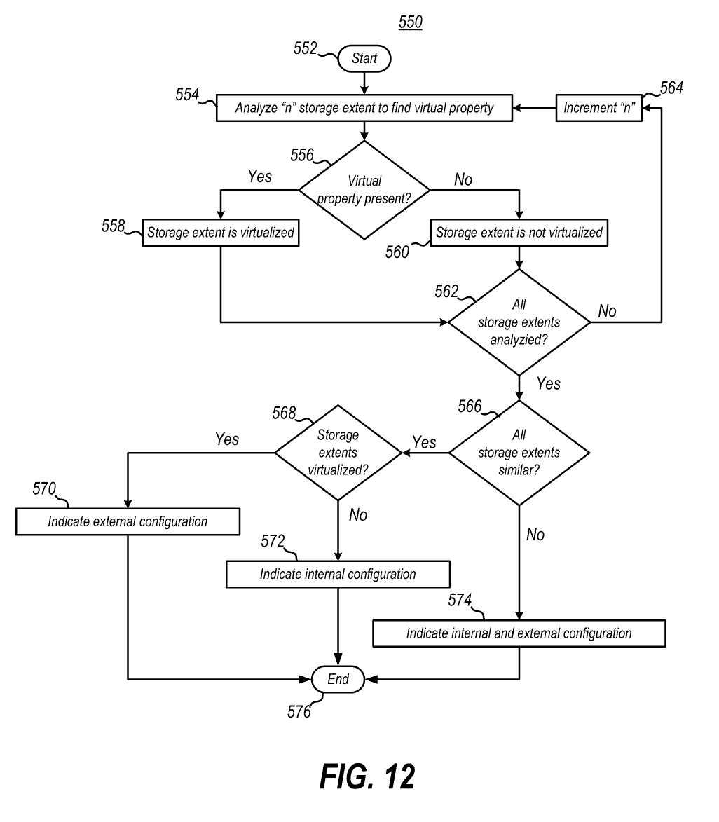

FIG. 12 depicts a block diagram of a method 550 of determining the configuration of a storage system 100 or of a managed disk group 101, according to various embodiments of the present invention. In certain embodiments, method 550 may be implemented by reporting device 200 to determine the configuration. In certain embodiments, method 550 may be implemented by reporting device 200 in conjunction with other components within storage environment 10 to determine the configuration.

Method 550 begins at block 552 and continues with analyzing whether a virtual property exists within or is associated with a particular storage extent 113 (block 554). For example, reporting engine 202, configuration manager 214, etc. may query or analyze a storage extent 113 to determine if a virtual property exits. A virtual property may be any indicia included or associated with the location of the storage extent 113. For example, a virtual property will exist when a storage extent 113 is located in external storage 122. Method 550 continues with determining whether the virtual property is present within the storage extent 113 analyzed (block 556). If the virtual property is present, the storage extent 113 is virtualized (block 558). If the virtual property is not present, the storage extent 113 is not virtualized (block 560). Method 550 continues by determining whether all of the storage extents have been analyzed (block 562). For example, it may be determined whether all of the storage extents 113 associated with a storage device 100 have been analyzed or it may be determine whether all of the storage extents 113 within a managed disk group 101 have been analyzed. If not all of the storage extents 113 have been analyzed, a next storage extent 113 is analyzed (block 564) and method 550 returns to block 554.

If all of the storage extents 113 have been analyzed, method 550 continues by determining whether all of the analyzed storage extents 113 are similar (block 566). If all of the storage extents 113 are not similar, internal and external storage configuration is indicated (block 574). If all of the storage extents 113 are similar, method 550 continues with determining whether all of the analyzed storage extents 113 are virtualized (block 568). If all of the analyzed storage extents 113 are virtualized, external storage configuration is indicated (block 570). If all of the analyzed storage extents 113 are not virtualized, internal storage configuration is indicated (block 572). Method 550 ends at block 576. In various embodiments, the determined configuration is associated with the particular storage system 100 and/or managed disk group 101 and stored within configuration manager 114. In various other embodiments, the determined configuration is associated with the particular storage system 100 and/or managed disk group 101 and stored within reporting device 200.

The accompanying figures and this description depicted and described embodiments of the present invention, and features and components thereof. Those skilled in the art will appreciate that any particular nomenclature used in this description was merely for convenience, and thus the invention should not be limited by the specific process identified and/or implied by such nomenclature. Therefore, it is desired that the embodiments described herein be considered in all respects as illustrative, not restrictive, and that reference be made to the appended claims for determining the scope of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention claimed is:

1. A storage environment comprising:
a storage system that may operate in a first configuration utilizing only internal storage and that may operate in a second configuration utilizing only external storage, and;
a reporting device that determines the operating configuration of the storage system and generates a report comprising at least one field identifying the storage system, and at least one field identifying the operating configuration of the storage system.

2. The storage environment of claim 1 wherein the storage system may further operate in a third configuration utilizing both internal storage and external storage.

3. The storage environment of claim 2 wherein the reporting device determines the operating configuration of the storage system by analyzing each of a plurality of storage extents for a virtual property.

4. The storage environment of claim 3, wherein the reporting device determines the storage system is operating in the first configuration if it does not find a virtual property associated with any of the plurality of storage extents.

5. The storage environment of claim 3, wherein the reporting device determines the storage system is operating in the second configuration if it does find a virtual property associated with all of the plurality of storage extents.

6. The storage environment of claim 3, wherein the reporting device determines the storage system is operating in the third configuration if it does find a virtual property associated with at least one of the plurality of storage extents and if it does not find a virtual property associated with at least one other of the plurality of storage extents.

7. The storage environment of claim 1 wherein the storage system comprises a configuration manager that communicates virtual properties associated with storage extents to the reporting device.

8. A storage environment comprising:
a storage system comprising a plurality of managed disk groups, each particular managed disk group may operate in a first configuration comprising only internal storage and may operate in a second configuration comprising only external storage, and;
a reporting device that determines the operating configuration of at least one managed disk group and generates a report comprising at least one field identifying the managed disk group, and at least one field identifying the operating configuration of the managed disk group.

9. The storage environment of claim 8 wherein the managed disk group may further operate in a third configuration comprising both internal storage and external storage.

10. The storage environment of claim 9 wherein the reporting device determines the operating configuration of the managed disk group by analyzing each of a plurality of storage extents comprised within the managed disk group.

11. The storage environment of claim 10, wherein the reporting device determines the managed disk group is operating in the first configuration if it does not find a virtual property associated with any of the plurality of storage extents.

12. The storage environment of claim 10, wherein the reporting device determines the managed disk group is operating in the second configuration if it does find a virtual property associated with all of the plurality of storage extents.

13. The storage environment of claim 10, wherein the reporting device determines the managed disk group is operating in the third configuration if it does find a virtual property associated with at least one of the plurality of storage extents and if it does not find a virtual property associated with at least one other of the plurality of storage extents.

14. The storage environment of claim 8 wherein the storage system comprises a configuration manager that communicates virtual properties associated with a plurality of storage extents comprised within the managed disk group to the reporting device.

15. A report comprising:
at least one field identifying a storage system that may operate in a first configuration utilizing only internal storage and that may operate in a second configuration utilizing only external storage, and
at least one field identifying the operating configuration of the storage system.

16. The report of claim 15 further comprising:
at least one field identifying a managed disk group that may operate in a first configuration comprising only internal storage and that may operate in a second configuration comprising only external storage.

17. The report of claim 16 further comprising:
at least one field identifying the operating configuration of the managed disk group.

18. The report of claim 16 further comprising:
at least one field identifying a plurality of storage extents comprised within the managed disk group.

19. The report of claim 18 further comprising:
at least one field identifying a state of the plurality of storage extents.

20. The report of claim 19 wherein the state of the plurality of storage extents may either be virtual or non virtual.
